(19) United States
(12) Patent Application Publication
(10) Pub. No.: US 2017/0349770 A1
(43) Pub. Date: Dec. 7, 2017

(54) INK COMPOSITIONS FOR 3D PRINTING, 3D PRINTER AND METHOD FOR CONTROLLING OF THE SAME

(71) Applicant: SAMSUNG ELECTRONICS CO., LTD., Suwon-si, Gyeonggi-do (KR)

(72) Inventors: Yeon Kyoung JUNG, Seoul (KR); Keon KUK, Yongin-si (KR); Oh Hyun BEAK, Seoul (KR)

(73) Assignee: SAMSUNG ELECTRONICS CO., LTD., Suwon-si, Gyeonggi-do (KR)

(21) Appl. No.: 15/540,843

(22) PCT Filed: Dec. 24, 2015
(86) PCT No.: PCT/KR2015/014258

§ 371 Date: Jun. 29, 2017

(30) Foreign Application Priority Data
Dec. 29, 2014 (KR) 10-2014-0191781

(51) Int. Cl. C09D 11/101; B33Y 70/00; B33Y 10/00; B33Y 30/00; C09D 11/322; B29C 64/112

(52) U.S. Cl. CPC C09D 11/101; C09D 11/322; B29C 64/112; B33Y 10/00; B33Y 30/00; B33Y 70/00

(57) ABSTRACT

The present invention relates to an ink composition for 3D printing, a 3D printer and a method of controlling the 3D printer. An ink composition for 3D printing according to an aspect of the present invention may include surface-modified inorganic particles, a photocurable material crosslinked with the surface-modified inorganic particles and a photoinitiator which cures the photocurable material.

### TECHNICAL FIELD

The present invention relates to an ink composition for 3D printing, a 3D printer and a method of controlling the 3D printer, and more specifically, to an ink composition for 3D printing, which may control the transparency and rigidity of a 3D molded body.

### BACKGROUND ART

3D printing is a printing technique of converting computer aided design (CAD) output data into a 3D object using a CAD solid modeling system. 3D printing may be generally performed by stacking 2D layers on a layer-by-layer and point-by-point basis.

The 3D printing techniques may be classified into liquid-based techniques, powder-based techniques, and solid-based techniques according to properties of source materials. Examples of the liquid-based techniques include stereolithography (SLA), jetted photopolymer printing, and ink jet printing, and ink jet printing may be classified into thermal bubble printing and Micro Piezo printing according to methods of printing ink. Thermal bubble printing is a method in which a heating wire or heating device is attached to a nozzle for jetting ink and vaporizes ink to make bubbles by instantly increasing temperature up to hundreds of degrees, and ink bubbles pop out of the nozzle due to increased pressure. Micro Piezo printing is a method in which an ultrafine piezoelectric device is mounted on a nozzle for jetting ink and applies physical pressure such as electrical vibration thereto, thereby jetting ink.

According to 3D printing, a layer is formed by an ink, and another ink layer is stacked thereon without a separate base material to realize a shape. Therefore, when an ink color is transparent, it is difficult to realize a desired color. On the other hand, when particles such as titanium oxide (TiO2) are used to obtain a white color or opacity, there is a problem of storage stability because precipitates are generated, and thus additional maintenance and repair work such as ink circulation is required.

### DISCLOSURE

### Technical Problem

An aspect of the present invention provides an ink composition for 3D printing, and more specifically, provides an ink composition for 3D print including inorganic particles which are surface-modified by a silane coupling agent.

### Technical Solution

An ink composition for 3D according to an aspect of the present invention printing includes: surface-modified inorganic particles; a photocurable material crosslinked with the surface-modified inorganic particles; and a photoinitiator which cures the photocurable material.

Further, the inorganic particles may include inorganic particles which are surface-modified by a silane coupling agent.

Further, the silane coupling agent may include one or more selected from the group consisting of a silane coupling agent having an acrylate functional group, a silane coupling agent having a methacrylate functional group and a vinyl triethoxy silane coupling agent.

Further, the inorganic particles may include one or more metal oxides selected from the group consisting of silica (SiO2), titanium oxide (TiO2), zirconium oxide (ZrO2) and aluminum hydroxide (AlOOH).

Further, the transparency of a 3D molded body molded using the ink composition for 3D printing may depend on a size of the inorganic particles.

Further, the transparency of the 3D molded body may increase as the size of the inorganic particles decreases.

Further, a size of the inorganic particles may range from several nanometers to tens of micrometers.

Further, the photocurable material may include one or more selected from the group consisting of acrylate-based and methacrylate-based compounds having one or more unsaturated functional groups.

Further, the photocurable material may include one or more selected from the group consisting of a hydroxyl group-containing acrylate-based compound, a water-soluble acrylate-based compound, a polyester acrylate-based compound, a polyurethane acrylate-based compound, an epoxy acrylate-based compound and a caprolactone-modified acrylate-based compound.

Further, the photoinitiator may include a compound which generates radicals by radiation of ultraviolet (UV) or visible light.

Further, the photoinitiator may include one or more selected from the group consisting of an α-hydroxyketone-based photocuring agent, a phenylglyoxylate-based photocuring agent, a bisacylphosphine-based photocuring agent and an α-aminoketone-based photocuring agent.

Further, the ink composition for 3D printing may include: the surface-modified inorganic particles at 5 to 50 wt %; the photocurable material at 35 to 85 wt %; and the photoinitiator at 1 to 15 wt %.

Further, a coloring agent may be further included.

Further, the coloring agent may include one or more selected from the group consisting of a dye, a pigment, a self-dispersing pigment, and a mixture thereof.

Further, an organic solvent may be further included.

Further, the organic solvent may include one or more selected from the group consisting of an alcohol compound, a ketone compound, an ester compound, a polyhydric alcohol compound, a nitrogen-containing compound and a sulfur-containing compound.

A 3D printer according to an aspect of the present invention includes: one or more print heads; a stage on which compositions ejected from the print heads are stacked; and an ink composition for 3D printing accommodated in the one or more print heads, wherein the ink composition for 3D printing includes: surface-modified inorganic particles; a photocurable material crosslinked with the surface-modified inorganic particles; and a photoinitiator for curing the photocurable material.

Further, the inorganic particles and the photocurable material may be accommodated in one print head.

Further, the print heads may include: a first print head for accommodating the inorganic particles and the photocurable material; and a second print head for accommodating the photocurable material.

Further, the first print head may selectively eject the ink composition included in the first print head.

A method of controlling the 3D printer according to an aspect of the present invention includes: supplying a molding material to one or more print heads; supplying a surface-modified inorganic particle composition to the one or more print heads; and ejecting the molding material and the surface-modified inorganic particle composition onto a stage.

Further, the supplying of a surface-modified inorganic particle composition to the one or more print heads may include supplying a surface-modified inorganic particle composition to the one or more print heads supplied with the molding materials.

Further, the ejecting of the molding material and the surface-modified inorganic particle composition onto a stage may include selectively ejecting a molding material which includes the inorganic particles.

Further, the inorganic particles may include inorganic particles which are surface-modified by a silane coupling agent.

Further, the inorganic particles may include one or more metal oxides selected from the group consisting of silica (SiO2), titanium oxide (TiO2), zirconium oxide (ZrO2) and aluminum hydroxide (AlOOH).

Further, the molding material may include one or more selected from the group consisting of a photocurable material crosslinked with the inorganic particles and a photoinitiator for curing the photocurable material.

Further, the molding material may further include a coloring agent.

### Advantageous Effects

The ink composition for 3D printing configured as described above has the following effects.

First, the rigidity of the 3D molded body can be ensured by introducing surface-modified inorganic particles.

Further, the transparency of the 3D molded body can be controlled by controlling the size of surface-modified inorganic particles.

Moreover, the dispersibility in the photocurable material can be improved by modifying the surface of inorganic particles using a silane coupling agent including an acrylate functional group, and less precipitates of inorganic particles are generated, accordingly.

### DESCRIPTION OF DRAWINGS

These and/or other aspects will become apparent and more readily appreciated from the following description of exemplary embodiments, taken in conjunction with the accompanying drawings of which:

FIG. 1 is a view illustrating a process of modifying the surface of inorganic particles using a silane coupling agent;

FIG. 2 is a view illustrating surface-modified inorganic particles and a photocurable material which are crosslinked;

FIG. 3 is a perspective view of a 3D printer according to an embodiment of the present invention;

FIG. 4 is a view illustrating an example of ink compositions for 3D printing accommodated in print heads;

FIG. 5 is a perspective view of print heads moving in a first direction in a 3D printer according to an embodiment of the present invention;

FIG. 6 is a perspective view of a stage moving in a second direction in a 3D printer according to an embodiment of the present invention;

FIG. 7 is a perspective view of a stage moving in a third direction in a 3D printer according to an embodiment of the present;

FIG. 8 is a perspective view of a 3D printer according to another embodiment of the present invention; and

FIG. 9 is a view illustrating ink compositions for 3D printing accommodated in print heads.

### BEST MODE

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Hereinafter, an ink composition for 3D printing, a 3D printer and a method of controlling the 3D printer will be described in detail in conjunction with the appended drawings.

The term “3D molded body” used in the present specification may refer to a molded body molded using an ink composition for 3D printing.

Further, the term “molding material” used herein may refer to a material provided for molding a 3D molded body.

First, an ink composition for 3D printing will be described in detail.

An ink composition for 3D printing according to an aspect of the present invention may include surface-modified inorganic particles, a photocurable material crosslinked with the surface-modified inorganic particles, and a photoinitiator curing the photocurable material. In the present specification, the ink composition for 3D printing aims to mold a 3D molded body, and thus the photocurable material and the photoinitiator may be referred to as a molding material which is a broader term.

The inorganic particles may be surface-modified inorganic particles, and more specifically, may be inorganic particles which are surface-modified by a silane coupling agent. Examples of the silane coupling agent may include one or more selected from the group consisting of a silane coupling agent having an acrylate functional group, a silane coupling agent having a methacrylate functional group and a vinyl triethoxy silane coupling agent (VTES), but are not limited thereto.

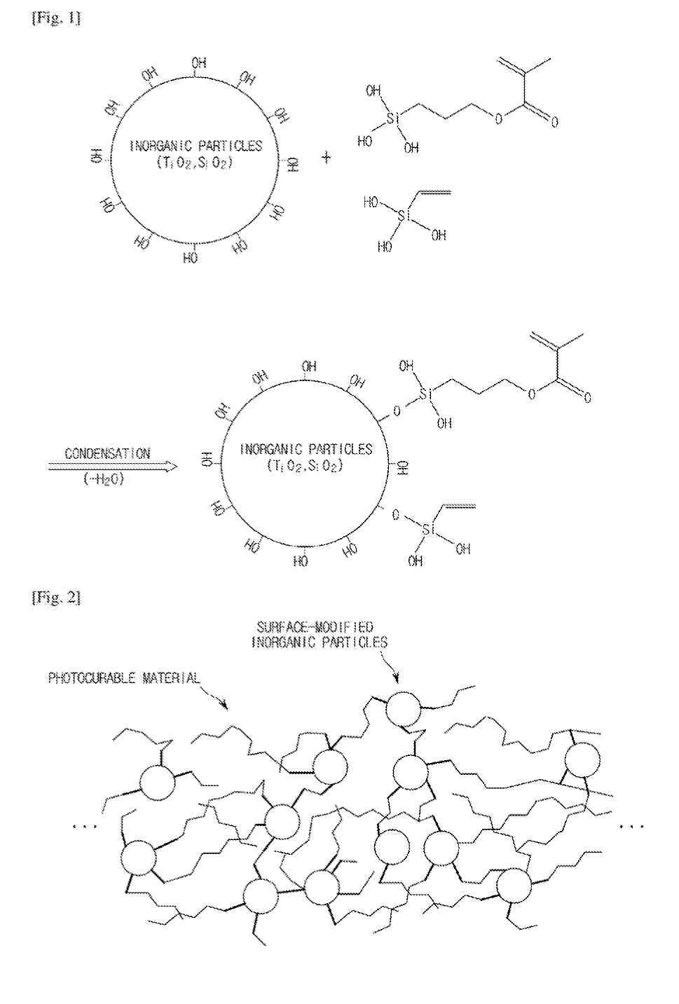

FIG. 1 is a view illustrating a process of modifying the surface of inorganic particles using a silane coupling agent.

Referring to FIG. 1, the surface of the inorganic particles includes a hydroxyl group (—OH). The inorganic particles may be surface-modified by a condensation reaction with a hydroxyl group of the silane coupling agent. That is, a hydroxyl group on the surface of the inorganic particles and a hydroxyl group in a silane coupling agent undergo a condensation reaction to remove a water molecule (H2O), and thereby a silane coupling agent may be attached to the surface of the inorganic particles by the medium of an oxygen atom.

In FIG. 1, although a silane coupling agent having an acrylate functional group and a vinyl triethoxy silane coupling agent were exemplified, the present invention is not limited thereto.

The surface of the inorganic particles includes an acrylate functional group or the like as a result of the surface modification, and the surface of the inorganic particles becomes hydrophobic as a result. A molding material may also be hydrophobic, and thereby dispersibility of surface-modified inorganic particles in the molding material is improved to cope with the problem of precipitates.

Further, an acrylate functional group or the like included in a silane coupling agent is crosslinked with a nearby photocurable material during photocuring, and thus rigidity of the 3D molded body may be ensured. Hereinafter, crosslinking of the surface-modified inorganic particles and the photocurable material will be described in further detail.

FIG. 2 is a view illustrating surface-modified inorganic particles and a photocurable material which are crosslinked.

Referring to FIG. 2, the surface-modified inorganic particles may be crosslinked with the photocurable material to form a net structure. More specifically, an acrylate functional group or the like on the surface of the inorganic particles and the photocurable material are bound, or the photocurable materials are bound to each other to form a net structure.

Here, since the degree of the surface modification of the inorganic particles is higher, the dispersion stability in the ink composition is higher, the degree of bonding with the photocurable material is also increased, and thus the rigidity of the 3D molded body is also improved. Therefore, the dispersion stability of the inorganic particles in the ink composition and the rigidity of the 3D molded body may be enhanced by applying suitable surface modification conditions.

The rigidity of the 3D molded body may be improved not only by the degree of crosslinking but also by the properties of the inorganic particles. Examples of the inorganic particles may include one or more metal oxides selected from the group consisting of silica (SiO2), titanium oxide (TiO2), zirconium oxide (ZrO2) and aluminum hydroxide (AlOOH), and the rigidity of the 3D molded body may be ensured by the basic properties of these metal oxides.

The transparency of the 3D molded body may depend on the size of the inorganic particles included in the 3D ink composition. More specifically, the transparency of the 3D molded body may increase as the size of the inorganic particles decreases, and the opacity of the 3D molded body may increase as the size of the inorganic particles increases.

According to an embodiment of the present invention, the inorganic particles may have a size ranging from several nanometers to tens of micrometers. More specifically, the size may range from 5 nm to 50 um. Here, when the inorganic particles have a circular shape, the size of the inorganic particles is defined as the diameter of the inorganic particles. When the inorganic particles have an oval shape, the size of the inorganic particles is defined as the length of the major axis of the oval.

The desired transparency of the 3D molded body may be controlled by controlling the scale of the inorganic particles. In an example, when the scale of the inorganic particles is 100 nm or less, a transparent 3D molded body may be realized. On the other hand, when the size of the inorganic particles is more than 100 nm, an opaque 3D molded body may be realized.

Further, when the size of the inorganic particles is too large, the viscosity of the ink composition for 3D printing may become too high, resulting in a decrease in the dispersion stability of the ink composition. Accordingly, it is preferable to appropriately control the upper limit of the size of the inorganic particles, and the inorganic particles may have a diameter of 50 um or less according to an embodiment of the present invention.

Further, the inorganic particles may be included at 5 to 50 wt % based on the total weight of the 3D ink composition. When the content of the inorganic particles is too low, the effect of improving rigidity may be low. When the content of the inorganic particles is too high, viscosity increases, and thus it is difficult to implement jetting properties. Therefore, the amount of the inorganic particles included in the 3D ink composition may be controlled according to desired properties of the 3D molded body.

The photocurable material is a material which is polymerized by light irradiation, and may be provided as a monomer or an oligomer (hereinafter, referred to as a “photocurable monomer”, etc.) The photocurable material may be included at 35 to 85 wt % based on the total weight of the 3D ink composition. When the photocurable monomer or the like is irradiated with light, the photocurable monomer or the like may absorb light to be activated, followed by a polymerization reaction.

The photocurable material may be an acrylate-based or methacrylate-based compound having at least one unsaturated functional group. In an example, the photocurable material may include at least one compound selected from the group consisting of a hydroxyl group-containing acrylate-based compound, a water-soluble acrylate-based compound, a polyester acrylate-based compound, a polyurethane acrylate-based compound, an epoxy acrylate-based compound, and a caprolactone-modified acrylate-based compound.

Further, the photocurable material may be a copolymer formed by polymerization of at least two types of acrylate or methacrylate monomers.

The photoinitiator is a material which initiates photocuring of the photocurable material, and may be added as necessary. In an example, the photoinitiator may be included at 1 to 15 wt % based on the total weight of the 3D ink composition.

The photoinitiator may be any compound which may generate radicals by radiation of ultraviolet (UV) or visible light without limitation. Particularly, the photoinitiator may include one or more selected from the group consisting of an α-hydroxyketone-based photocuring agent, a phenylglyoxylate-based photocuring agent, and a bisacylphosphine-based photocuring agent, or an a-aminoketone-based photocuring agent. In an example, the photoinitiator may be 1 -hydroxy-cyclohexyl-phenyl-ketone, a mixture of oxy-phenylacetic acid 2-[2-oxo-2-phenyl-acetoxy-ethoxy]-ethyl ester and oxy-phenyl-acetic acid 2-[2-hydroxy-ethoxy]-ethyl ester, bis(2,4,6-trimethylbenzoyl)phenylphosphine oxide, 2-hydroxy-2-methyl-1 -phenyl-1 -propanone and 2-methyl-1[4-(methylthio)phenyl-2-(4-morpholinyl)-1-propanone.

Further, the photoinitiator may be a single compound or a mixture of two or more types of compounds.

The ink composition for 3D printing may further include a coloring agent according to an embodiment of the present invention. The coloring agent may be included at 0.01 to 3 wt % based on the total weight of the ink composition for 3D printing.

The coloring agent may include at least one selected from the group consisting of a dye, a pigment, a self-dispersing pigment and a mixture thereof.

Specific examples of the dye include food black dyes, food red dyes, food yellow dyes, food blue dyes, acid black dyes, acid red dyes, acid blue dyes, acid yellow dyes, direct black dyes, direct blue dyes, direct yellow dyes, anthraquinone dyes, momoazo dyes, disazo dyes, and phthalocyanine dyes.

Specific examples of the pigment include carbon black, graphite, vitreous carbon, activated charcoal, activated carbon, anthraquinone, phthalocyanine blue, phthalocyanine green, diazos, monoazos, pyranthrones, perylene, quinacridone, and indigoid pigments.

The ink composition for 3D printing may further include an organic solvent according to an embodiment of the present invention. In an example, when molding is performed using thermal bubble printing-type heads, the ink composition may include the organic solvent for low viscosity in the ink composition and to ensure jetting properties through bubbling.

The organic solvent may include one or more selected from the group consisting of an alcohol compound, a ketone compound, an ester compound, a polyhydric alcohol compound, a nitrogen-containing compound and a sulfur-containing compound, without being limited thereto.

Subsequently, the present invention will be described in further detail with reference to specific examples. The following examples and comparative examples are for illustrative purposes only and are not intended to limit the scope of the invention.

### EXAMPLE 1

### Surface Modification of Inorganic Particles of Colloidal Silica

75 g of colloidal silica (Ludox HS40 (12 nm); manufactured by Sigma-Aldrich Corporation) and 125 g of distilled water were put into a reactor installed with a stirrer and stirred. The temperature of the reactor was raised to 70° C. while continuously stirring, 0.4 ml of nitric acid was added to the mixture, and 40 ml of MPTMS (3-(trimethoxysilyl)propyl methacrylate; manufactured by Sigma-Aldrich Corporation) was further added to the mixture. After about 15 minutes, spherical aggregates were formed by hydrolysis and condensation reactions between silica and silane, and then stirring was stopped and the aggregates were removed from the reactor and filtered, thereby obtaining silica particles which were surface-modified by an organosilane compound.

### EXAMPLE 2

### Surface Modification of Inorganic Particles of Boehmite

20 g of Boehmite (Disperal HP14/2 (170 nm); manufactured by Sasol Chemical Industries Ltd.) and 400 g of distilled water were put into a reactor installed with a stirrer and stirred at 40° C. The temperature of the reactor was raised to 70° C. while continuously stirring, 59.2 ml of 3-(trimethoxysilyl)propyl methacrylate (MPTMS; manufactured by Sigma-Aldrich Corporation) and 17.6 ml of vinyltriethoxysilane (VTES; manufactured by Sigma-Aldrich Corporation) were further added to the mixture. After about 35 minutes, spherical aggregates were formed by hydrolysis and condensation reactions between silica and silane, and then stirring was stopped and aggregates were removed from the reactor and filtered, thereby obtaining Boehmite particles which were surface-modified by an organosilane compound.

### EXAMPLES 3 to 5

The surface-modified silica particles obtained from Example 1, a photocurable material (manufactured by Miwon Specialty Chemical Co., Ltd.) and a photoinitiator (manufactured by BASF Corporation) were mixed to prepare a molding material containing inorganic particles. The components and the component ratios in Examples 3 to 5 are as shown in Table 1.

TABLE 1

| | Inorganic | | |
|---|---|---|---|
| | particles | Photocurable material | Photoinitiator |
| Example 3 | Surface- | PU210 (30%), M262 (20%), | Irgacure 184 (6%) |
| | modified | M170 (20%), M1140 (12%) | Irgaure 819 (2%) |
| | silica (10%) | | |
| Example 4 | Surface- | PU210 (24%), M262 (16%), | Irgacure 184 (6%) |
| | modified | M170 (20%), M1140 (12%) | Irgaure 819 (2%) |
| | silica (20%) | | |
| Example 5 | Surface- | PU210 (18%), M262 (12%), | Irgacure 184 (6%) |
| | modified | M170 (20%), M1140 (12%) | Irgaure 819 (2%) |
| | silica (30%) | | |

### EXAMPLE 6

A molding material containing surface-modified Boehmite was prepared in the same manner as in Example 3 except that surface-modified silica was replaced with the surface-modified Boehmite of Example 2.

### COMPARATIVE EXAMPLE 1

A molding material containing no inorganic particles was prepared in the same manner as in Example 2 except that surface-modified silica was not used, and the contents of PU 210 and M262 were respectively changed to 35% and 25%.

### EXPERIMENTAL EXAMPLE 1

100 ml of each molding material containing inorganic particles prepared according to Examples 3 to 6 was added to a glass bottle, the glass bottle was sealed and stored at room temperature for one month. The existence of precipitates and layer separation were checked, and dispersion stability was evaluated. The results are as shown in the following Table 2.

TABLE 2

| | Example 3 | Example 4 | Example 5 | Example 6 |
|---|---|---|---|---|
| Dispersion | ◯ | ◯ | ◯ | ◯ |
| stability | | | | |

In Table 2, “O” indicates no precipitates, in other words, no layer separation. That is, molding materials containing inorganic particles prepared according to Examples 3 to 6 have no precipitates and no layer separation as shown in Table 2.

### EXPERIMENTAL EXAMPLE 2

The measured modulus of a molded body (20×20×2 mm) prepared by 3D printing each of molding materials containing inorganic particles prepared according to Examples 3 to 5 and a molding material containing no inorganic particles prepared according to Comparative Example 1 is as shown in the following Table 3.

TABLE 3

| | | | | Comparative |
|---|---|---|---|---|
| | Example 3 | Example 4 | Example 5 | Example 1 |
| Modulus [GPa] | 3.1~3.7 | 4.4~4.5 | 5.0~5.4 | 1.1~2.1 |

As shown in Table 3, the molding materials containing inorganic particles prepared according to Examples 3 to 5 have high modulus values, and the molding material containing no inorganic particles prepared according to Comparative Example 1 has a relatively low modulus value as compared to molding materials prepared according to Examples 3 to 5. Accordingly, it was determined that a molding material containing inorganic particles has a higher modulus value than that of a molding material containing no inorganic particles.

### EXPERIMENTAL EXAMPLE 3

A haze value of a molded body obtained by putting each of the molding material containing inorganic particles prepared according to Example 6 and the molding material containing no inorganic particles prepared according to Comparative Example 1 into a molding cartridge and controlling them to be in a predetermined ratio during 3D printing is as shown in the following Table 4.

TABLE 4

| | Mixing ratio of molding materials of Example 6 and | | | | |
|---|---|---|---|---|---|
| | Comparative Example 1 | | | | |
| | 5:0 | 4:1 | 3:2 | 1:4 | 0:5 |
| Haze | 84 | 73 | 56 | 27 | 1.9 |

As a result of Experimental Example 3, it was determined that as the ratio of the mixed molding material prepared according to Example 6 increases, the haze value increases, and also determined that as the ratio of the mixed molding material prepared according to Comparative Example 1 increases, the haze value decreases. That is, it was determined that a desired haze value of a molded body may be obtained by controlling the mixing ratio of inorganic particles.

Next, a 3D printer which performs 3D printing using the aforementioned ink composition for 3D printing and a control method thereof will be described in detail.

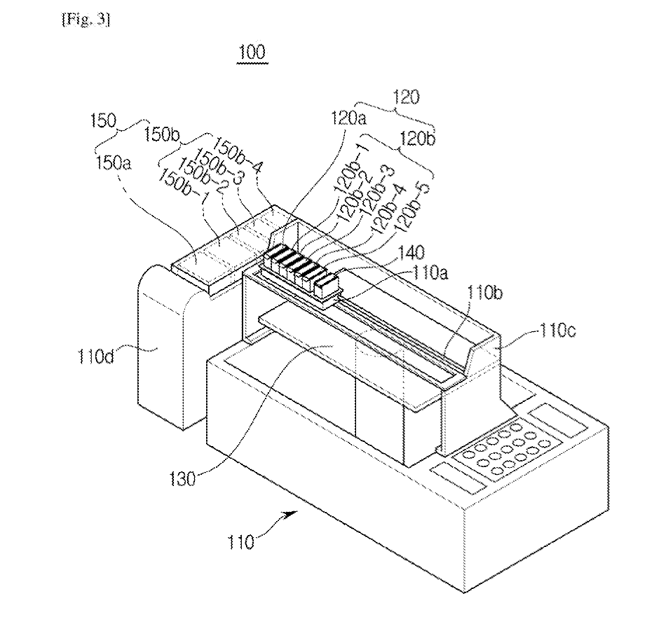

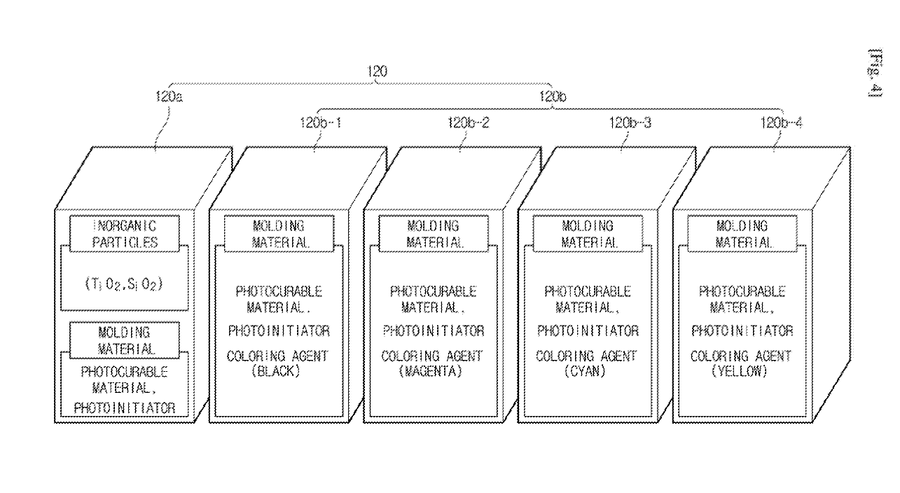

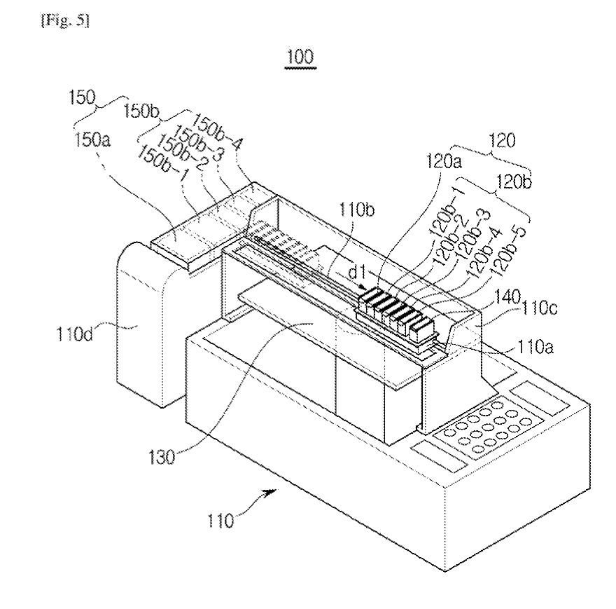

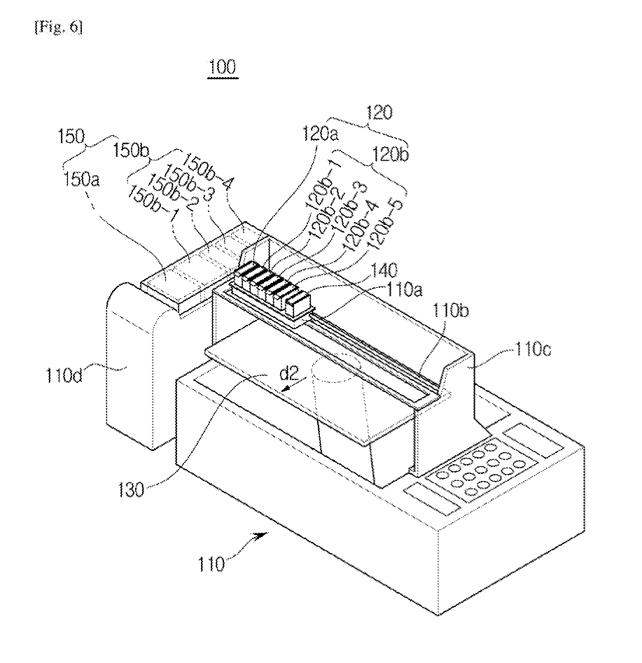

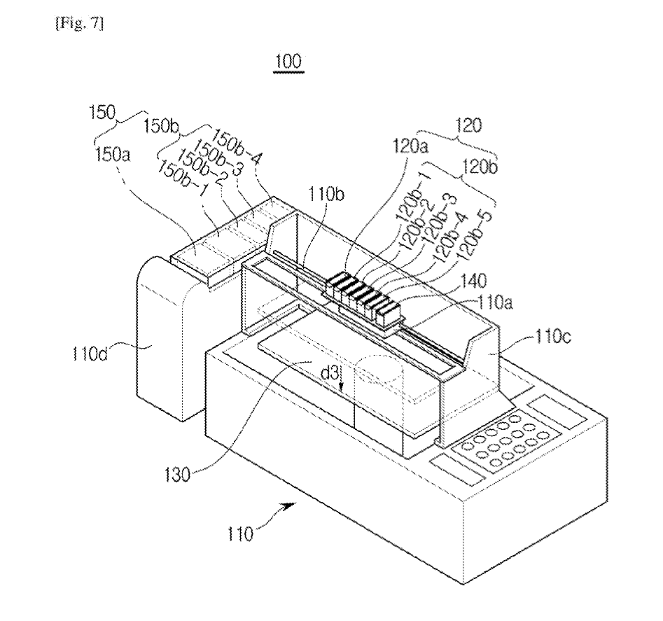

FIG. 3 is a perspective view of a 3D printer 100 according to an embodiment of the present invention, FIG. 4 is a view illustrating an example of ink compositions 100 for 3D printing accommodated in print heads 120, FIG. 5 is a perspective view of print heads 120 moving in a first direction in a 3D printer 100 according to an embodiment of the present invention, FIG. 6 is a perspective view of a stage 130 moving in a second direction in a 3D printer 100 according to an embodiment of the present invention, and FIG. 7 is a perspective view of a stage 130 moving in a third direction in a 3D printer 100 according to an embodiment of the present.

Referring to FIGS. 3 and 4, the 3D printer 100 according to an embodiment of the present invention may include: a main body 110; one or more print heads 120 positioned on the main body 110 to eject ink compositions downward; a stage 130 on which ink compositions ejected from the one or more print heads 120 are stacked; a light source 140 for curing the ink compositions stacked on the stage 130 by irradiating with light; and one or more ink tanks 150 for supplying the ink compositions to one or more print heads 120. Here, the ink composition may be an ink composition for 3D printing, and more specifically, may be an ink composition for 3D printing which includes surface-modified inorganic particles, a photocurable material crosslinked with the surface-modified inorganic particles and a photoinitiator for curing the photocurable material.

The main body 110 may include a transport module 110 a on which the print heads 120 and the light source 140 are mounted; a guide rail 110b extending in a first direction d1 to guide the movement of the transport module 110a in the first direction d1; and a support bracket 110c for supporting two ends of the guide rail 110b. An ink accommodating unit 110d on which the one or more ink tanks 150 are detachably mounted may be provided at a side of the main body 110.

The print heads 120 may be mounted on the main body 110 to be horizontally moved in the first direction d1 through the transport module 110 a and guide rail 110b of the main body 110. That is, the print heads 120 may be mounted to be horizontally moved in the first direction d1 as shown in FIG. 5.

One or a plurality of print heads 120 may be provided. When one print head 120 is provided, inorganic particles and a molding material may be accommodated in the same print head 120. In this case, the molding material may include a photocurable material crosslinked with the surface-modified inorganic particles and a photoinitiator for curing the photocurable material, and may further include a coloring agent as necessary.

On the other hand, when a plurality of the print heads 120 are provided, each print head 120 may accommodate both of the inorganic particles and the molding material, or some print heads may accommodate both of the inorganic particles and the molding material and the other print heads may accommodate only the molding material according to an embodiment of the present invention.

The print heads 120 may include a first print head 120a and a second print head 120b according to an embodiment of the present invention. Hereinafter, the first print head 120a is defined as a print head for accommodating both of a surface-modified inorganic particle composition and a molding material, and the second print head 120b is defined as a print head for accommodating a molding material. The molding material accommodated in the second print head 120b may include a photocurable material and a photoinitiator for curing the photocurable material, but is not limited thereto, and may further include a coloring agent.

In FIGS. 3 and 4, the case of one first print head 120a was exemplified, but a plurality of the first print heads 120a may also be provided. Further, when the plurality of the first print heads 120a are provided, a plurality of the first print heads 120a may be disposed between the second print heads 120b.

When a coloring agent or the like is further accommodated in the second print heads 120b, the second print heads 120b may include a 2-1 print head 120b-1 to eject a black ink composition, a 2-2 print head 120b-2 to eject a magenta ink composition, a 2-3 print head 120b-3 to eject a cyan ink composition, and a 2-4 print head 120b-4 to eject a yellow ink composition. However, configuration examples of the second print heads 120b are not limited thereto, and may be modified within a scope which may be easily conceived by those skilled in the art.

Each print head 120 may eject the composition, and the ink compositions may be selectively ejected according to the desired transparency, rigidity and color of a 3D molded body. For example, a molding material including inorganic particles may be selectively ejected from the first print head 120a according to the desired transparency and rigidity of a 3D molded body, and a molding material including a relevant coloring agent may be selectively ejected from the second print head 120b according to the desired color of a 3D molded body.

These print heads 120 may include head chips (not shown) disposed on the bottom surface of each of the print head to eject the ink compositions onto the stage 130 below.

The stage 130 may be formed in a flat plate shape horizontally disposed, and may be installed to be horizontally moved in a second direction d2, perpendicular to the first direction d1. Further, the stage 130 may be installed movably in a third direction d3 which is vertical to the first direction d1 and the and second direction d2 as shown in FIG. 7.

Accordingly, a 3D object having a length, a width, and a height may be manufactured on the stage 130 by combining operations of the print heads 120, which may move in the first direction d1, and operations of the stage 130, which may move in the second direction d2 and third direction d3.

The light source 140 may be mounted on the transport module 110 a together with the print heads 120 and emit light toward ink compositions ejected from the print heads 120, while moving with the print heads 120 in the first direction d1.

The light source 140 may be a UV lamp which generates UV rays and emits the UV rays toward the stage 130. The ink compositions for 3D printing may be UV-curable ink compositions which are cured by UV rays.

The light source 140 may be a light-emitting diode (LED) type UV lamp according to an embodiment of the present invention. When the light source 140 is an LED type UV lamp, it is advantageous in that the LED type UV lamp consumes low power due to low heat generation and may be mounted on the transport module 110 a together with the print heads 120 due to a small size.

One or more ink tanks 150 may include a first ink tank 150a to store the surface-modified inorganic particle composition and a molding material to be supplied to the first print head 120a. Further, the one or more ink tanks 150 may include a second ink tank 150b to store an ink composition to be supplied to the second print head 120b. More specifically, the second ink tank 150b may include a 2-1 ink tank 150b-1 to store the black ink composition to be supplied to the 2-1 print head 120b-1, a 2-2 ink tank 150b-2 to store the magenta ink composition to be supplied to the 2-2 print head 120b-2, a 2-3 ink tank 150b-3 to store the cyan ink composition to be supplied to the 2-3 print head 120b-3, and a 2-4 ink tank 150b-4 to store the yellow ink composition to be supplied to the 2-4 print head 120b-4.

These ink tanks 150 may be detachably mounted on the ink accommodating unit 110d disposed at a side of the main body 110 and supply the compositions to the print heads 120 via connection tubes (not shown).

When the ink tanks 150 are detachably mounted on the main body 110 separately from the print heads 120, large amounts of the ink compositions may be stored in the ink tanks 150 by increasing the sizes thereof, and the ink tanks 150 may be easily replaced after the ink compositions are used up.

Hereinafter, a method of controlling the 3D printer 100 according to the present embodiment will be described in detail.

A method of controlling the 3D molded body according to the embodiment of the present invention may include: supplying molding materials to one or more print heads 120; supplying surface-modified inorganic particle compositions to the one or more print heads 120; and ejecting the molding materials and the surface-modified inorganic particle compositions onto a stage 130.

The supplying of surface-modified inorganic particle compositions to the one or more print heads 120 includes supplying of surface-modified inorganic particle compositions to the one or more print heads 120 supplied with the molding materials. When one print head 120 is provided, the inorganic particles and the molding material may be accommodated in the same print head 120. On the other hand, when a plurality of the print heads 120 are provided, each print head 120 may accommodate both of the inorganic particles and the molding material, or some print heads may accommodate both of the inorganic particles and the molding material, and the other print heads may accommodate only the molding material according to an embodiment of the present invention. Hereinafter, the case in which an inorganic particle composition and a molding material are supplied to the first print head 120a and a molding material is supplied to the second print head 120b will be described as an example for ease of illustration.

When the inorganic particle composition and the molding material are supplied to the print heads 120, each print head 120a and 120b may eject the ink compositions accommodated in the print heads 120a and 120b to the stage 130. Here, the print heads 120a and 120b may selectively eject the ink compositions according to the desired shape of the 3D object.

The ink compositions having photocurable properties and ejected onto the stage 130 may be cured by light emitted by the light source 140 while being moved by the transport module 110a in the first direction d1.

The ejecting and curing of the ink compositions may be repeatedly performed while the transport module 110 a moves in the first direction d1 as shown in FIG. 5, thereby forming a line in the first direction d1.

The line formation may be repeated while the stage 130 is moved in the second direction d2 by a predetermined distance as shown in FIG. 6, thereby forming a plane. Further, the plane formation may be repeated while the stage 130 is moved in the third direction d3 by a predetermined distance after the plane is formed, as shown in FIG. 7, thereby completing the manufacture of the 3D object.

The case of the stage 130 moving up and down was exemplified in the present embodiment, but the present invention is not limited thereto, and the print heads 120 may move up and down instead of the stage 130.

Next, a 3D printer 100a according to another embodiment of the present invention will be described in detail.

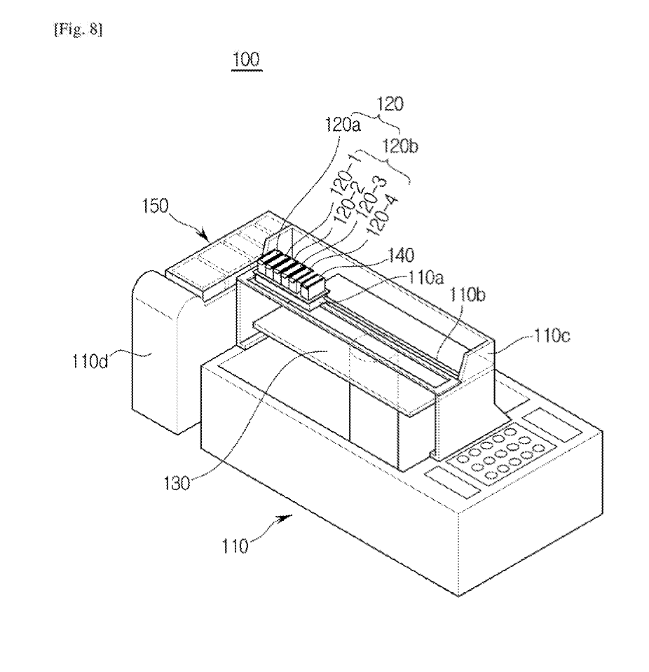

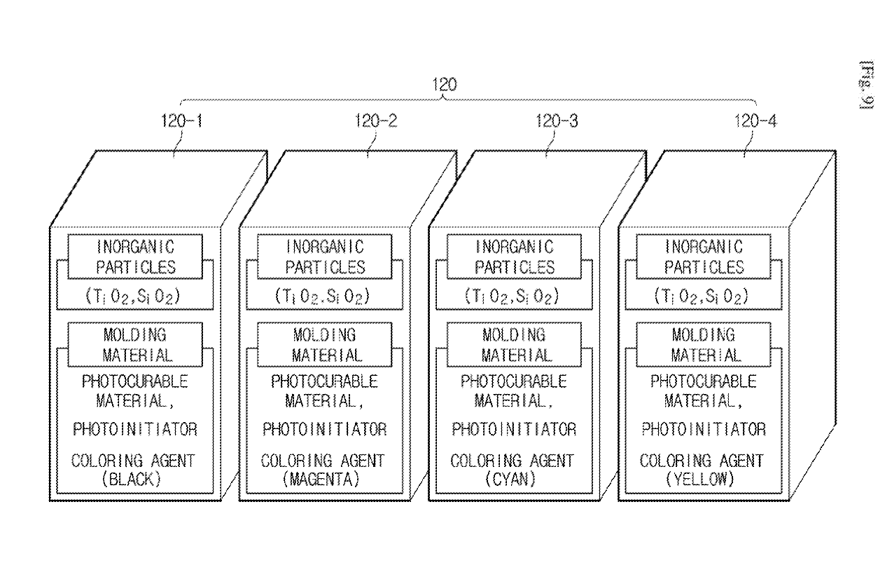

FIG. 8 is a perspective view of a 3D printer 100a according to another embodiment of the present invention, and FIG. 9 is a view illustrating ink compositions for 3D printing accommodated in print heads 120.

Referring to FIGS. 8 and 9, the 3D printer 100a according to another embodiment of the present invention may include: a main body 110; one or more print heads 120 positioned on the main body 110 to eject ink compositions downward; a stage 130 on which ink compositions ejected from the one or more print heads 120 are stacked; a light source 140 for curing the ink compositions stacked on the stage 130 by irradiating with light; and one or more ink tanks 150 for supplying the ink compositions to one or more print heads 120. Here, the ink composition may be an ink composition for 3D printing.

Further, the descriptions about the main body 110, stage 130 and light source 140 of the 3D printer 100 shown in FIG. 8 may be the same as those of the main body 110, stage 130 and light source 140 of the 3D printer 100 shown in FIG. 3. Hereinafter, the differences from FIG. 3 will be mainly explained.

Referring to FIGS. 8 and 9, the print heads 120 of the 3D printer 100a according to another embodiment of the present invention may be mounted on the main body 110 to be horizontally moved in a first direction d1 by the transport module 110 a and the guide rail 110b.

A plurality of the print heads 120 may be provided. Although the case in which a plurality of the print heads 120 are used, and inorganic particles and molding materials each are accommodated in the print heads 120 different from each other was exemplified in FIG. 3, the inorganic particles and the molding materials may be accommodated in each of the same print heads 120 in the present embodiment.

That is, both of the inorganic particles and molding materials may be accommodated in each of the print heads 120-1, 120-2, 120-3 and 120-4 according to the present embodiment, and a separate print head 120b (refer to FIG. 3) for accommodating only the molding material may not be provided. Here, the molding materials accommodated in the print heads 120-1, 120-2, 120-3 and 120-4 different from each other may include different types of coloring agents.

In an example, the print heads 120-1, 120-2, 120-3 and 120-4 may include a first print head 120-1, a second print head 120-2, a third print head 120-3, and a fourth print head 120-4. Surface-modified inorganic particles and molding materials may be accommodated in each of the print heads 120-1, 120-2, 120-3 and 120-4, and the molding material may include a photocurable material, a photoinitiator and a coloring agent. Here, the print heads 120-1, 120-2, 120-3 and 120-4 different from each other may accommodate different types of coloring agents.

In an example, the print heads 120-1, 120-2, 120-3 and 120-4 may include the first print head 120-1 to eject a black ink composition, the second print head 120-2 to eject a magenta ink composition, the third print head 120-3 to eject a cyan ink composition, and the fourth print head 120-4 to eject a yellow ink composition. However, configuration examples of the print heads 120-1, 120-2, 120-3 and 120-4 are not limited thereto, and may be modified within a scope which may be easily conceived by those skilled in the art.

Each of the print heads 120-1, 120-2, 120-3 and 120-4 may eject the composition, and ink compositions may be selectively ejected according to the desired color of a 3D molded body. For example, ink compositions including relevant coloring agents may be selectively ejected from the first to fourth print heads 120-1, 120-2, 120-3 and 120-4 according to the desired color of a 3D molded body.

The invention has been illustrated and described with respect to specific embodiments. However, the invention is not limited to the above embodiments, and thus it is apparent to those skilled in the art that various modifications, additions and substitutions are possible, without departing from the scope and spirit of the invention as disclosed in the accompanying claims.

1. An ink composition for 3D printing, comprising:
surface-modified inorganic particles;
a photocurable material crosslinked with the surface-modified inorganic particles; and
a photoinitiator which cures the photocurable material.

2. The ink composition of claim 1, wherein the inorganic particles include inorganic particles which are surface-modified by a silane coupling agent.

3. The ink composition of claim 2, wherein the silane coupling agent includes at least one selected from the group consisting of a silane coupling agent having an acrylate functional group, a silane coupling agent having a methacrylate functional group and a vinyl triethoxy silane coupling agent.

4. The ink composition of claim 1, wherein the inorganic particles include at least one metal oxide selected from the group consisting of silica (SiO2), titanium oxide (TiO2), zirconium oxide (ZrO2) and aluminum hydroxide (AlOOH).

5. The ink composition of claim 1, wherein transparency of a 3D molded body molded using the ink composition for 3D printing depends on a size of the inorganic particles.

6. The ink composition of claim 5, wherein the transparency of the 3D molded body increases as the size of the inorganic particles decreases.

7. The ink composition of claim 1, wherein a size of the inorganic particles ranges from several nanometers to tens of micrometers.

8. The ink composition of claim 1, wherein the photocurable material includes at least one selected from the group consisting of acrylate-based and methacrylate-based compounds having at least one unsaturated functional group.

9. The ink composition of claim 8, wherein the photocurable material includes at least one selected from the group consisting of a hydroxyl group-containing acrylate-based compound, a water-soluble acrylate-based compound, a polyester acrylate-based compound, a polyurethane acrylate-based compound, an epoxy acrylate-based compound and a caprolactone-modified acrylate-based compound.

10. The ink composition of claim 1, wherein the photoinitiator includes a compound which generates radicals by radiation of ultraviolet (UV) or visible light.

11. The ink composition of claim 1, wherein the photoinitiator includes at least one selected from the group consisting of an a-hydroxyketone-based photocuring agent, a phenylglyoxylate-based photocuring agent, a bisacylphosphine-based photocuring agent and an a-aminoketone-based photocuring agent.

12. The ink composition of claim 1, comprising the surface-modified inorganic particles at 5 to 50 wt %; the photocurable material at 35 to 85 wt %; and the photoinitiator at 1 to 15 wt %.

13. The ink composition of claim 1, further comprising a coloring agent.

14. The ink composition of claim 13, wherein the coloring agent includes at least one selected from the group consisting of a dye, a pigment, a self-dispersing pigment, and a mixture thereof.

15. The ink composition of claim 1, further comprising an organic solvent.

16. The ink composition of claim 15, wherein the organic solvent includes at least one selected from the group consisting of an alcohol compound, a ketone compound, an ester compound, a polyhydric alcohol compound, a nitrogen-containing compound and a sulfur-containing compound.

17. A 3D printer, comprising:
at least one print head;
a stage on which compositions ejected from the at least one print head are stacked; and
an ink composition for 3D printing accommodated in the at least one print head,
wherein the ink composition for 3D printing includes:
surface-modified inorganic particles;
a photocurable material crosslinked with the surface-modified inorganic particles; and
a photoinitiator which cures the photocurable material.

18. The 3D printer of claim 17, wherein the inorganic particles and the photocurable material are accommodated in one print head.

19. The 3D printer of claim 17, wherein the at least one print head includes:
a first print head which accommodates the inorganic particles and the photocurable material; and
a second print head which accommodates the photocurable material.

20. The 3D printer of claim 19, wherein the first print head selectively ejects the ink composition included in the first print head.

21. A method of controlling the 3D printer, comprising:
supplying a molding material to at least one print head;
supplying a surface-modified inorganic particle composition to the at least one print head; and
ejecting the molding material and the surface-modified inorganic particle composition onto a stage.

22. The method of claim 21, wherein the supplying of a surface-modified inorganic particle composition to the at least one print head includes supplying a surface-modified inorganic particle composition to the at least one print head supplied with the molding materials.

23. The method of claim 22, wherein the ejecting of the molding material and the surface-modified inorganic particle composition onto a stage includes selectively ejecting a molding material which includes the inorganic particles.

24. The method of claim 21, wherein the inorganic particles include inorganic particles which are surface-modified by a silane coupling agent.

25. The method of claim 21, wherein the inorganic particles include at least one metal oxide selected from the group consisting of silica (SiO2), titanium oxide (TiO2), zirconium oxide (ZrO2) and aluminum hydroxide (AlOOH).

26. The method of claim 21, wherein the molding material includes at least one selected from the group consisting of a photocurable material crosslinked with the inorganic particles, and a photoinitiator which cures the photocurable material.

27. The method of claim 21, wherein the molding material further includes a coloring agent.
